(19) United States
(12) Patent Application Publication
(10) Pub. No.: US 2004/0012539 A1
(43) Pub. Date: Jan. 22, 2004

(54) Apparatus for displaying image by using residual image effect

(76) Inventor: Ung-Sang Ryu, Seoul (KR)

Correspondence Address: PARK & SUTTON LLP, 3255 WILSHIRE BLVD, SUITE 1110, LOS ANGELES, CA, 90010, US

(21) Appl. No.: 10/416,814

(22) PCT Filed: Nov. 9, 2001
(86) PCT No.: PCT/KR01/01902

(30) Foreign Application Priority Data
Nov. 9, 2000 (KR) 200066542

(51) Int. Cl. G09G 5/00

(52) U.S. Cl. 345/1.1

(57) ABSTRACT

Disclosed relates to an apparatus for providing moving or still images to a passenger in a moving train through a plurality of monitors established in a railway tunnel by using a residual image effect. The apparatus of the invention comprises a main server including image data, such as moving or still images, a controller, connected to the main server through a dedicated network or Internet, for controlling the image data transmitted from the main server, and a plurality of monitors, installed at predetermined intervals in a tunnel, for receiving the image data from the controller and displaying the moving or still image.

### TECHNICAL FIELD

The present invention relates to an apparatus for displaying images by using a residual image effect and, more particularly, to an apparatus for providing moving or still images to a passenger in a running train through a plurality of monitors established in a railway tunnel by using the residual image effect. A main server of the apparatus supplies image data to the plural monitors by way of a dedicated network or Internet.

### BACKGROUND ART

In general, the inside of the tunnel, through which automobiles, or railway trains travel, is kept relatively darker than the other bus stops or railway stations. Besides, the inside of the tunnel is not easily used for any advertisement medium, whereas various advertising means, such as pictures, outdoor billboards or electric signboards, are established in the railway station and the bus stops. That is, the inside of the tunnel is a useless space, except for its peculiar function for providing a traveling space of the vehicles.

### DISCLOSURE OF INVENTION

Accordingly, the present invention is made to provide an apparatus for displaying moving or still images to a passenger in a running train through a plurality of monitors established in a railway tunnel, using a residual image effect.

To accomplish of the invention, the apparatus for displaying images by using residual image effect comprises a main server including image data, such as moving or still images; a controller, connected to the main server through a dedicated network or Internet, for controlling the image data transmitted from the main server; and a plurality of monitors, installed at predetermined intervals in a tunnel, for receiving the image data from the controller and displaying the moving or still images.

It is to be understood that both the foregoing general description and the following detailed description are exemplary and explanatory and are intended to provide further explanation of the invention as claimed.

### BRIEF DESCRIPTION OF DRAWINGS

FIG. 1 is an outline showing how an apparatus for displaying images by using a residual image effect in accordance with the present invention is established in a tunnel; and

FIG. 2 shows how divided images stored in a controller are supplied to a plurality of monitors.

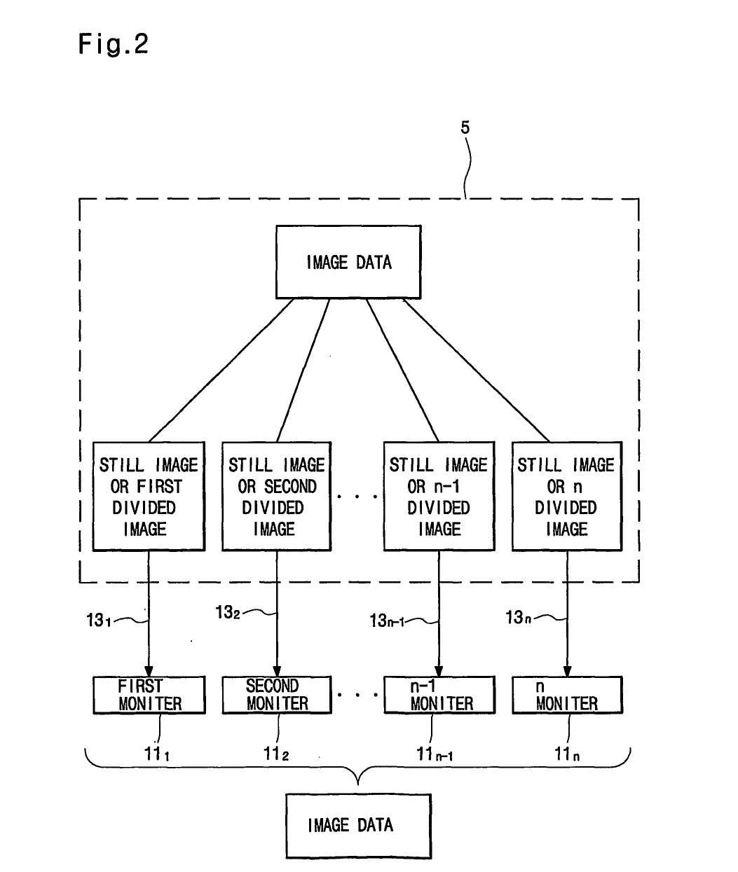

### BEST MODE FOR CARRYING OUT THE INVENTION

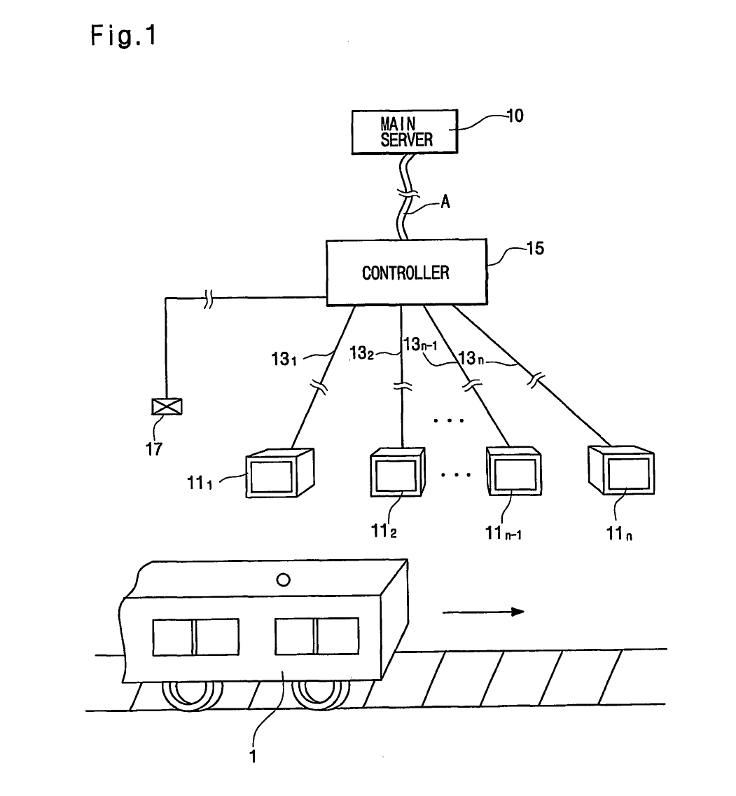

Referring to FIG. 1, the apparatus for displaying image by using residual image effect in accordance with the present invention includes a plurality of monitors (11₁-11ₙ) installed at regular intervals in the tunnel. Each of the monitors (11₁-11ₙ), connected to a controller (15) by means of dedicated lines (13₁-13ₙ), receives image data. The monitor (11) is made of a CRT monitor, an LCD monitor, or an LED monitor.

Besides, the apparatus for displaying image using residual image effect includes a sensor (17), established in the tunnel, for detecting the speed of running vehicles. The sensor (17) is coupled to the controller (15) and transmits the detected speed.

Meanwhile, according to a preferred embodiment of the invention, the controller (15) is interfaced with the running vehicle by radio and receives the speed covered. That is, the controller (15) provides divided image data to each of the monitors (11₁-11ₙ) according to the covering speed received from the vehicle.

The controller (15) is connected with a main server (10) including image data such as moving or still images by way of a dedicated network (A) or Internet. The main server (10) has an input means for inputting image data, a storing means for storing the image data input from the input means and a transmitting means for transmitting the image data to the controller (15).

Meanwhile, according to a preferred embodiment of the invention, the image data input to the main server (10) are divided at predetermined periods according to the covering speed of vehicle. The divided image data are sent to the plural monitors (11₁-11ₙ) through the dedicated lines (13₁-13ₙ). Accordingly, when a subway train (1), for example, goes into the tunnel, the traveling speed of the vehicle, detected by the sensor (17) or transmitted from the vehicle, is received to the controller (15). Then, the controller (15) forwards a plural number of divided images corresponding to a specific image data, for example, n-divided image, to each of the monitors (11₁-11ₙ) through the dedicated lines (13₁-13ₙ). That is, first divided image is supplied to first monitor (11₁) through first dedicated line (13₁); second divided image is provided to second monitor (11₂) through second dedicated line (13₂); n₋₁ divided image is sent to n₋₁ monitor (11ₙ₋₁) through n₋₁ dedicated line (13ₙ₋₁); and n divided image is forwarded to n monitor (11ₙ) through n dedicated line (13ₙ), such that the specific moving image can be viewed by the passenger in the covering train.

The divided moving images displayed on each of the monitors (11₁-11ₙ) create a residual image effect on the passenger in the traveling train (1). That is, the passenger can obtain various information through the moving or still images displayed on the monitors (11₁-11ₙ) according as the train penetrates in the tunnel.

Meanwhile, each of the monitors (11₁-11ₙ) is spaced away at predetermined intervals so that the passenger of the train (1) can recognize is the divided moving image by the residual image effect. That is, the passenger giving a glance at the first divided image on the first monitor (11₁) meets the second divided image on the second monitor (11₂) adjacent to the first monitor (11₁) before the residual image of the first divided image disappears, such that the passenger can recognize the first and second divided images consecutively. Accordingly, the process of recognition is made in consecutive order till the passenger recognizes the n divided image displayed on the n monitor (11ₙ) such that the passenger appreciates moving or still images in the train penetrating into the tunnel.

Industrial Applicability

The apparatus for displaying image by using residual image effect in accordance with the invention provides moving or still images to the passenger in the vehicle through the plural monitors established in the tunnel. Accordingly, it can make an additional use of the tunnel space, used only for traveling of vehicles.

1. An apparatus for displaying image using residual image effect comprising:
a main server including image data, such as moving or still images;
a controller, connected to the main server through a dedicated network or Internet, for controlling the image data transmitted from the main server; and
a plurality of monitors, installed at predetermined intervals in a tunnel, for receiving the image data from the controller and displaying the moving or still images.

2. The apparatus for displaying image by using residual image effect as recited in claim 1,
wherein the controller divides moving image data received from the main server at predetermined periods and provides the divided image data to each of the monitors.

3. The apparatus for displaying image by using residual image effect as recited in claim 2,
wherein the controller controls a sequence of providing the divided image data to the monitors according to a direction of moving vehicle.

4. The apparatus for displaying image by using residual image effect as recited in claim 1, 2 or 3,
wherein the monitor is made of a CRT monitor, an LCD monitor or an LED monitor.

5. The apparatus for displaying image by using residual image effect as recited in claim 1,
wherein the controller, interfaced with a vehicle traveling in the tunnel by radio, controls the moving or still images displayed on the monitors according to a moving speed of the vehicle received from the vehicle.

6. The apparatus for displaying image by using residual image effect as recited in claim 1,
wherein the main server preserves a plurality of divided images, divided from moving image data stored therein at predetermined periods, and transmits the divided images to the controller.
